(19) United States
(12) Patent Application Publication
(10) Pub. No.: US 2009/0274570 A1
(43) Pub. Date: Nov. 5, 2009

(54) SELF-ALIGNING DYNAMIC CLEARANCE SEALS AND FLUID-MOVING DEVICES UTILIZING SUCH SEALS

(76) Inventor: Creigh THOMPSON, Chaska, MN (US)

Correspondence Address: MORRISON & FOERSTER LLP, 12531 HIGH BLUFF DRIVE, SUITE 100, SAN DIEGO, CA, 02130-2040, US

(21) Appl. No.: 12/433,536

(22) Filed: Apr. 30, 2009

Related U.S. Application Data
(60) Provisional application No. 61/049,400, filed on Apr. 30, 2008.

(51) Int. Cl. F04B 19/00; F16J 15/18

(52) U.S. Cl. 417/437; 277/512; 277/516

(57) ABSTRACT

A self-aligning dynamic clearance seal assembly is disclosed. The assembly comprises a stationary casing, a moving member, a housing member circumferentially disposed between the stationary casing and the moving member, a sealing member circumferentially disposed between the housing member and the moving member, and two elastomeric seals. The first elastomeric seal prevents the flow of a fluid into a gap between the sealing member and the stationary casing. The second elastomeric seal, when compressed, prevents the housing member from biasing against the sealing member. The sealing member and the moving member define a continuous and uniform gap having a size that allows the fluid to fill the gap but prevents the fluid from flowing through the gap from the first side to the second side of the opening under an operating pressure differential between the first and the second side. A pump utilizing the self-aligning seal assembly is also provided.

### CROSS-REFERENCE TO RELATED APPLICATIONS

This application claims the benefit of U.S. Ser. No. 61/049,400, filed Apr. 30, 2008, which is incorporated herein by reference in its entirety.

### FIELD OF THE INVENTION

The invention relates generally to fluid-tight dynamic seals between a reciprocating member and its housing. More particularly, the invention is directed to self-aligning dynamic clearance seals and fluid-moving equipment utilizing such seals, such as piston pumps.

### BACKGROUND OF THE INVENTION

In many types of fluid-moving equipment, such as liquid pumps, slurry pumps, dry mixers, and numerous other devices, a sliding plunger, rod, piston, or another similar member, reciprocally moves inside a stationary bearing. Typically, fluid leakage around the moving member is prevented by utilizing sealing structures. The material of the sealing structure is required to have some resiliency and yet some degree of stiffness which will permit the moving member to slide back and forth through the axial opening of the sealing structure and yet be tight enough to prevent or at least minimize leakage of the fluid around the moving member.

One type of a conventional sealing structure is a mechanical face seal. Typically, the mechanical face seal consists of one seal ring rotating with the driving shaft and one stationary seal ring attached to the surrounding housing. The two seal rings are pressed towards each other by a biasing force which, in this way, prevents a fluid from passing between them. For example, U.S. Pat. Nos. 3,282,235; 4,754,981 and 5,772,217 describe a seal with a spring for providing the biasing force. Usually, additional elastomeric components are required to seal each ring from the shaft or housing, correspondingly. Typically, a thin lubricating film is required between the seal surfaces to prevent their damage by dry friction. Nevertheless, with time, wear and vibrations cause the mating faces of the sealing rings to become scored, resulting in leakage of the process fluid. Environments where the process fluid is abrasive or contains a coagulant are particularly damaging to the conventional seals and require their frequent replacement.

Similarly, U.S. Pat. No. 3,348,849 discloses a reciprocating plunger packing including several metal rings circling the plunger and arranged with a predetermined clearance between the rings and the plunger. The rings are designed to contract under pressure to nearly close their clearances during operation of the plunger. When a fluid pressure is applied to each ring, the rings close down or contract on the plunger, thus reducing the initial clearance between the rings and the plunger. The pressure needed to effectively reduce the passage of fluid through the packing results in high friction between the metal rings and the plunger, damaging both the rings and the plunger.

A packed stuffing box is another example of a conventional seal for a moving member. This type of seal has been disclosed, for example, in U.S. Pat. Nos. 3,659,862 and 5,333,883. Generally, the packing is sufficiently compressed to limit the passage of fluid through the packing, but not so compressed as to create excess friction between the packing and the moving member. Pressure is generally maintained on the packing by manually tightening a gland on the stuffing box until the point where leakage through the packing is minimized, yet before the point where friction between the packing and the shaft creates overheating of the packing. Such a configuration operates on the principle of controlled leakage to the atmosphere rather than zero leakage. However, this requires frequent adjustment, and over tightening results in excess friction and heat buildup, excessive wear to the packing, and possibly even damage to the moving member. Even when the pressure on the packing is properly regulated, the pressure necessary to minimize the passage of fluid through the packing causes relatively high friction between the packing and the shaft. As a result, the packing wears out quickly and requires a frequent replacement.

One possible alternative to the packed seal is described in U.S. Pat. No. 6,843,481, which discloses a clearance seal assembly including a sealing member mounted in a cylindrical housing structure and circumferentially disposed between the housing structure and a moving piston. Referring to FIG. 1, the sealing member 4 has a fluid-tight relationship with the stationary casing 3 and the housing member 5. This fluid-tight relationship is accomplished by having an elastomeric O-ring 1 mounted on top of the sealing member to prevent fluid leakage across the top between the sealing member and the stationary casing. When the O-ring is compressed, the sealing member is locked to the surface of the housing member, thus preventing fluid flow. Due to a very tight clearance between the sealing member and the piston 2, the axial position of the sealing member and piston must be closely aligned with each other. However, the piston must also be aligned with the housing bore which acts as a guide for the piston. If these two axes are out of alignment, binding of piston motion results, damaging a drive belt driving the motion of the piston. Since very low tolerances are required in order to eliminate the binding of the piston to the sealing member, a large fraction of these seal assemblies tend to fail quality control, thus making it impractical to manufacture them on a large commercial scale.

Thus, the sealing structures of prior art do not provide reliable and long-lasting seals between moving members and their housing. The conventional seals undergo a lot of wear during normal operation and have to be replaced frequently, making prophylactic maintenance of the equipment more laborious and increasing its maintenance costs. The clearance seals often require very high standards of manufacture making mass production costly and impractical.

### SUMMARY OF THE INVENTION

Accordingly, it is an object of the present invention to provide improved dynamic seals which avoid the undesirable features of the prior art seals. Particularly, it is an object of the present invention to provide dynamic seals which have a low wear, may be produced at relatively low costs, and provide superior performance in use. It is a further object of the present invention to provide convenient fluid-moving devices utilizing such seals with relatively low maintenance cost and high reliability.

These and other objects are achieved in a self-aligning dynamic clearance seal assembly of the present invention. The assembly comprises a stationary casing defining a first side, a second side and an opening connecting the first and second side; a moving member having an external wall moveably disposed through the opening; a housing member having an internal wall and a ridge forming a recess in the housing member, the housing member circumferentially disposed between the stationary casing and the moving member; a sealing member having an internal wall, an external wall, a top surface, and a bottom surface, the sealing member circumferentially disposed between the housing member and the moving member; a first elastomeric seal disposed between the stationery casing and the top surface of the sealing member; and a second elastomeric seal disposed in the recess between the housing member and the bottom surface of the sealing member. The first elastomeric seal prevents the flow of a fluid into a gap between the sealing member and the housing member. The second elastomeric seal, when compressed, prevents the ridge of the housing member from biasing against the bottom surface of the sealing member. The sealing member and the moving member define a continuous and uniform gap having a size that allows the fluid to fill the gap but prevents the fluid from flowing through the gap from the first side to the second side of the opening under an operating pressure differential between the first and the second side. The size of this gap remains substantially unchanged under the operating pressure differential.

In another aspect, the invention provides a pump utilizing the clearance seal assembly of the present invention. The pump comprises a stationary casing having an internal wall defining a pressure chamber for containing a fluid; a piston having an external wall, the piston movably disposed within the pressure chamber; a housing member having an internal wall and a ridge forming a recess in the housing member, the housing member circumferentially disposed between the stationary casing and the piston; a sealing member having an internal wall, an external wall, a top surface, and a bottom surface, the sealing member circumferentially disposed between the housing member and the piston; a first elastomeric seal disposed between the stationery casing and the top surface of the sealing member; and a second elastomeric seal disposed in the recess between the housing member and the bottom surface of the sealing member. The first elastomeric seal prevents the flow of a fluid into a gap between the sealing member and the housing member. The second elastomeric seal, when compressed, prevents the ridge of the housing member from biasing against the bottom surface of the sealing member. The sealing member and the piston define a continuous and uniform gap having a size that allows the fluid to fill the gap but prevents the fluid from flowing from the pressure chamber to an outside of the chamber under an operating pressure differential. The size of this gap remains substantially unchanged under the operating pressure differential.

By eliminating a direct contact between the sealing member and the moving member, the present clearance seal assembly alleviates many of the problems associated with the conventional seals discussed above. In particular, the advantages of this approach include a minimal wear of the part, simplified assembly and maintenance, significantly improved reliability, and a decreased maintenance cost. The clearance seal of the present invention may be utilized in any device or system that requires drawing, moving, and dispensing of fluids. The invention may be particularly advantageous for use in high-precision pumps employed in analytical instrumentation. For example, a piston pump with a clearance seal manufactured in accordance with the present invention may be beneficially utilized for sample aspiration and dispensing in the Nexgen Access System (Beckman Instruments, Calif.), disclosed in a U.S. Pat. No. 6,825,041, which has been commonly assigned to the assignee of the present invention and relevant parts of which are incorporated by reference herein.

The present invention also overcomes the problems of the earlier clearance seal design disclosed in U.S. Pat. No. 6,843,481 through the innovative use of an additional elastomeric seal on the bottom surface of the sealing member. The purpose of this additional elastomeric seal is not to seal fluids but to act as a counterbalance to the first elastomeric seal, allowing both seals to act in concert as a suspension for the sealing member. This allows the sealing member to float enough to accommodate a misalignment between the housing and sealing member axes while maintaining enough pressure on the first elastomeric ring to enable it to accomplish its function of preventing fluid flow between the sealing member and the stationary casing. The distance that the sealing member can float is limited because the more the sealing member moves away from the normal position the more the restraining force is exerted on the sealing member. This is important because too much movement will result in inconsistent dispensation results. Testing of this self-aligning clearance seal design has shown vast improvements in functionality and reliability over the original clearance seal design disclosed in U.S. Pat. No. 6,843,481. For example, the first pass yield on a difficult volume dispense improved from 28% to 88% using the self-aligning clearance seal design.

### BRIEF DESCRIPTION OF THE FIGURES

The above-mentioned and other features of this invention and the manner of obtaining them will become more apparent, and will be best understood by reference to the following description, taken in conjunction with the accompanying drawings, in which:

FIG. 1A is a cross-sectional view of a clearance seal disclosed in U.S. Pat. No. 6,843,481. FIG. 1B is a side view of the sealing member along with a cross-sectional view of the moving member and the housing member. FIG. 1C is a top view of the sealing member along with a cross-sectional view of the moving member.

FIG. 2A is a cross-sectional view of a clearance seal according to one embodiment of the present invention. FIG. 2B is an enlarged side view of the sealing member along with a cross-sectional view of the moving member and the housing member. FIG. 2C is a top view of the sealing member along with a cross-sectional view of the moving member.

FIG. 3 is an enlarged cross-sectional view of a recess between the sealing member and the housing member according to one embodiment of the present invention.

### DETAILED DESCRIPTION OF THE INVENTION

Unless defined otherwise, all technical and scientific terms used herein have the same meaning as is commonly understood by one of ordinary skill in the art to which this invention belongs. All patents, patent applications (published or unpublished), and other publications referred to herein are incorporated by reference in their entireties. If a definition set forth in this section is contrary to or otherwise inconsistent with a definition set forth in the patents, applications, published applications and other publications that are incorporated herein by reference, the definition set forth in this section prevails over the definition that is incorporated herein by reference.

Citation of publications or documents is not intended as an admission that any of such publications or documents are pertinent prior art, nor does it constitute any admission as to the contents or date of these publications or documents.

As used herein, “a” or “an” means “at least one” or “one or more.”

As used herein, the term “self-aligning” refers to an assembly feature where two or more parts can be mutually joined without any alignment by a human operator required to achieve the desired junction.

As used herein, the term “flow” refers to a directional movement of a fluid caused by a pressure differential between an area of high pressure and an area of low pressure (e.g., the differential between operating fluid pressure inside the pump and atmospheric pressure outside the pump). The term “leakage” as used herein refers to a fluid movement caused by a reciprocal motion of the moving member and by adhesion of the fluid to the walls of solid structural elements due to electrostatic, capillary and/or van der Waals forces.

As used herein, the term “viscosity” refers to a measure of the resistance of a fluid to being deformed by either shear stress or extensional stress. Viscosity describes a fluid's internal resistance to flow and is sometimes thought of as a measure of fluid friction. Thus, water and ethanol are considered to have a relatively low viscosity, while glycerol and maple syrup are considered to have a relatively high viscosity. Viscosity of a fluid is usually independent of pressure (except at very high pressures) and tends to decrease as temperature increases. For example, water viscosity falls from 1.79 centipoise (cP) to 0.28 cP as water temperature rises from 0° C. to 100° C. As a function of temperature T (K), the viscosity of water may be determined as follows: μ(Pa·s)=A×10^{B/(T-C)}, where A=2.414×10⁻⁵ Pa·s ; B=247.8K; and C=140K [1 cP=10⁻³ Pa·s]. At room temperature (20° C.), the viscosity of water is 1.003 cP.

As used herein, the term “fluid-tight relationship” between two structural elements means that no fluid can pass between these elements. It is understood that any sealing method may be used to achieve a fluid-tight relationship, as long as it provides a reliable seal.

As used herein, the term “prevents a fluid from flowing” means that the volume of a fluid flowing past a seal is sufficiently small not to have a significant adverse effect on the precision of dispensation by a pump comprising the seal. Alternatively, as used herein, the term “prevents a fluid from flowing” means that the amount of a fluid flowing past a seal is too small to be detectable by the naked eye.

As used herein, the term “continuous gap” between two structural elements means that there are no points of direct contact between these elements. The term “uniform gap” between two structural elements means that the distance between these elements does not vary significantly so as to compromise a hydraulic seal formed between them. Accordingly, the term “continuous and uniform gap” as used herein refers to a spatial relationship between two structural elements wherein there are no points of direct contact, and the distance between the elements does not vary significantly so as to compromise a hydraulic seal formed between them.

As used herein, the term “substantially unchanged” refers to a change of less than about 50%, preferably less than about 40%, more preferably less than about 30%, more preferably less than about 20%, and most preferably less than about 10% in the property in question. Thus, the phrase “the size of the second gap remains substantially unchanged under operating pressure” generally means that the size of the second gap in operation does not deviate more than about 50% from the size of the second gap before operation.

As used herein, the term “substantially circular shape” includes, in addition to the perfect circle, a shape close to the perfect circle but transformed from a perfect circle due to variation in accuracy of the manufacturing process or the like. In more quantitative terms, the term “substantially circular shape” means that the ratio of a minor axis length A to a major axis length B is equal or less than about 1.0 and equal or greater than about 0.8 (i.e. 0.8≦A/B≦1.0).

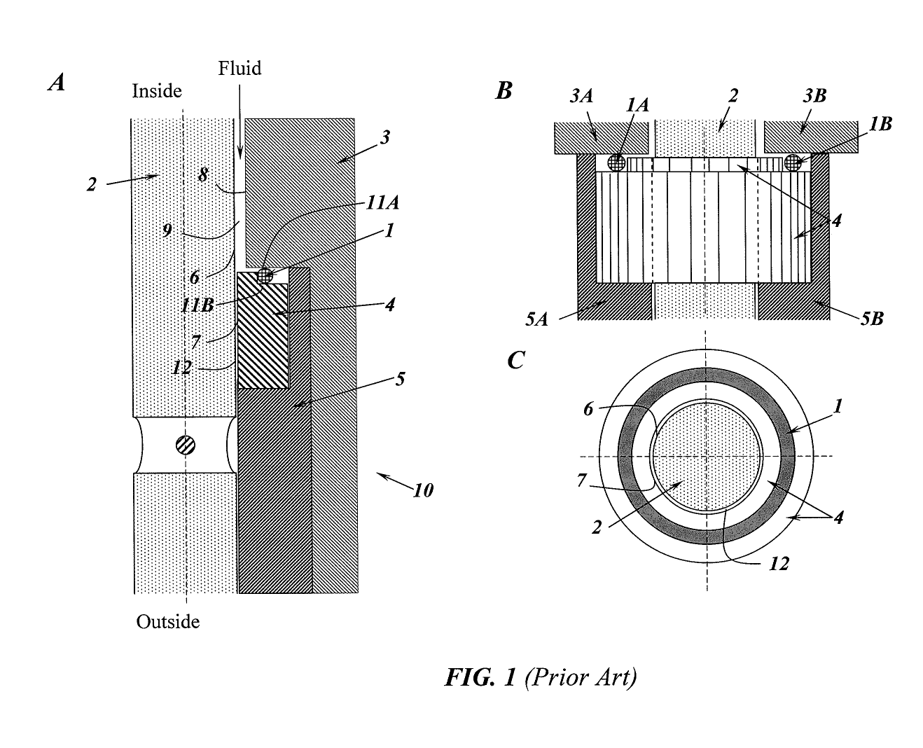

A previously disclosed clearance seal assembly employing a single elastomeric O-ring (see U.S. Pat. No. 6,843,481) is shown in FIG. 1. Referring to FIG. 1A, a piston pump with a clearance seal assembly 10 includes a stationary casing 3 with an internal wall 8 defining a pressure chamber 9 for containing a fluid being pumped. A piston 2 is movably disposed within the pressure chamber 9, and a cylindrical housing member 5 is circumferentially disposed between the stationary casing 3 and the piston 2 to support the piston. A sealing member 4 is circumferentially disposed between the housing member 5 and the piston 2 and has a fluid-tight relationship with the stationary casing 3. Referring to FIGS. 1A and 1B, the fluid-tight relationship between the sealing member 4 and the stationary casing 3 is typically accomplished by utilizing an annular elastomeric seal, such as an O-ring 1, which is removably mounted between the casing and the sealing member. When the O-ring 1 is compressed, it forms a sealing point 11A with the stationary casing 3 and a sealing point 11B with the sealing member 4, thus preventing fluid from flowing between the casing and the sealing member. Referring to FIGS. 1A and 1C, the internal wall 7 of the sealing member 4 and the external wall 6 of the piston 2 define a continuous and uniform gap 12. The gap 12 has a size that allows the fluid to fill the gap but prevents the fluid from flowing through the gap from the pressure chamber to an outside of the chamber under an operating fluid pressure.

However, as explained above, due to a very tight clearance between the sealing member 4 and the piston 2, a misalignment between the longitudinal axes of the housing and sealing members frequently results in an engagement of the piston 2 to the sealing member 4, causing damage to a drive belt effectuating the motion of the piston. Since very low tolerances are required in order to eliminate the frequent engagement of the piston 2 to the sealing member 4, a significant fraction of the seal assemblies fail quality control, thus making it impractical to manufacture this type of seal on a large commercial scale.

The present invention effectively overcomes these problems by providing a floating, self-aligning clearance seal utilizing an additional removable elastomeric seal on the bottom surface of the sealing member. The purpose of this second elastomeric seal is not to seal fluids, but to act as a counterbalance to the primary elastomeric seal, allowing both seals to act in concert as a suspension for the sealing member. This allows the sealing member to float enough to accommodate any misalignment between the housing and sealing member axes while maintaining sufficient pressure on the opposite elastomeric seal to enable it to accomplish its function of preventing fluid flow between the sealing member and the stationary casing.

It should be appreciated that the clearance seal assembly of the present invention may be used in an association with any device having a stationary member with an opening and a moving member reciprocating through the opening. Examples of such devices include, but are not limited to, dispensing pumps, slurry pumps, and impeller pumps, used in a broad range of applications. The moving member may be, for example, a sliding plunger, rod, or piston. While a particular configuration of the invention may take on different or modified forms, a piston pump will be used to illustrate the invention in more detail.

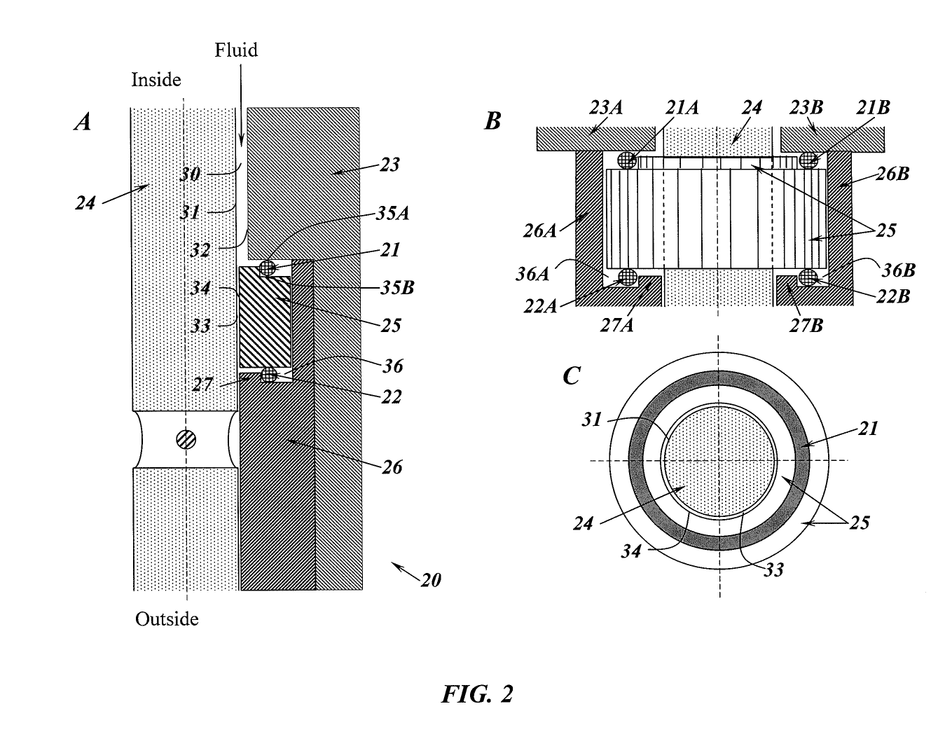

Referring to FIG. 2A, a piston pump with a clearance seal assembly 20 includes a stationary casing 23 with an internal wall 32 defining a pressure chamber 30 for containing a fluid being pumped. A piston 24 is movably disposed within the pressure chamber 30, and a cylindrical housing member 26 is circumferentially disposed between the stationary casing 23 and the piston 24 to support the piston. As before, a sealing member 25 is circumferentially disposed between the housing member 26 and the piston 24. As before, the sealing member 25 has a fluid-tight relationship with the stationary casing 23, which is accomplished by having a first annular elastomeric seal, such as an O-ring 21, removably mounted between the sealing member 25 and the casing 23. When the first seal 21 is compressed, it forms a sealing point 35A with the casing 23 and a sealing point 35B with the sealing member 25, thus preventing fluid from flowing between the casing and the sealing member. The precise position of the first seal 21 is not important, as long as it prevents fluid from flowing between the stationary casing 23 and the sealing member 25. Referring to FIGS. 2A and 2C, the internal wall 34 of the sealing member 25 and the external wall 31 of the piston 24 define a continuous and uniform gap 33. The gap 33 has a size that allows the fluid to fill the gap but prevents the fluid from flowing through the gap from the pressure chamber to an outside of the chamber under an operating fluid pressure. Referring to FIGS. 2A and 2B, the housing member 26 of the present invention has a ridge 27 that forms a recess 36 between the housing member and the sealing member 25. A second annular elastomeric seal, such as an O-ring 22, is removably mounted in the recess 36 between the housing member 26 and the sealing member 25 to prevent the ridge 27 from coming into contact with, and biasing against, the sealing member 25. By having the second O-ring 22 mounted in the recess 36 between the sealing member 25 and the housing member 26, the sealing member is given an additional degree of freedom, thus promoting a more effective alignment between itself and the movable piston 24 and preventing binding between these two structural elements.

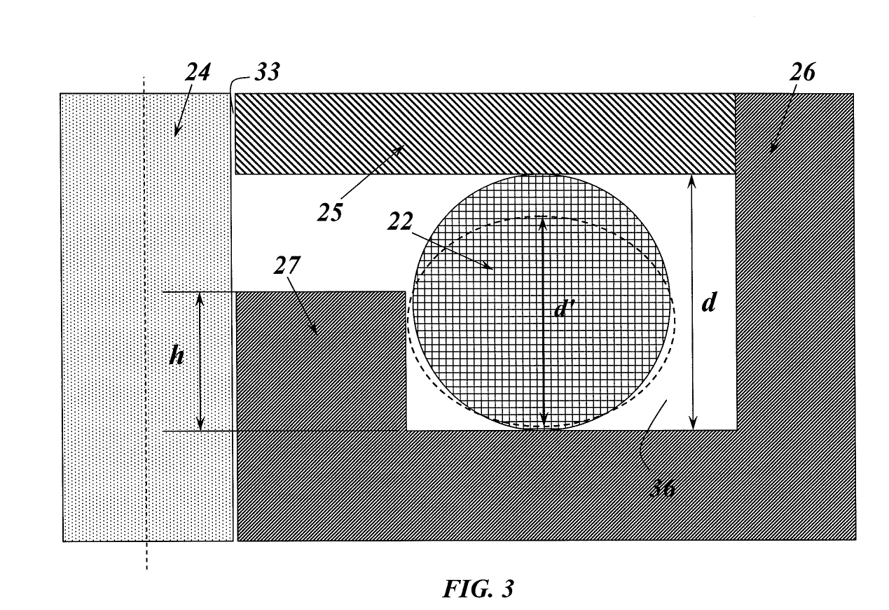

Referring to FIG. 3, the key elements distinguishing the present invention from the clearance seal disclosed in U.S Pat. No. 6,843,481 are a second elastomeric seal, such as the O-ring 22, which is mounted between the sealing member 25 and the housing member 26, and the ridge 27, which forms a recess 36 in the housing member 26, said recess being able to accommodate the second O-ring 22 in order to prevent the ridge 27 from biasing against the sealing member 25. The second O-ring 22 may be made of any suitable resilient material, such as, for example, synthetic rubber, thermoplastic, or the like. The height of the ridge 27 must be carefully calibrated in relation to the diameter of the body portion of the second O-ring 22, so that when the second 0-ring 22 is compressed, the sealing member 25 does not come into contact with the ridge 27 and continues to float on top of the second O-ring 22. It would be appreciated by a person skilled in the art that the desired ratio between the height h of the ridge 27 and the uncompressed diameter d of the body portion of the second O-ring 22 will usually depend on the hardness of the material from which the second O-ring 22 is made. Thus, in one embodiment, the second O-ring 22 has a compressed body portion diameter d′, and the ratio of the compressed diameter d′ to the uncompressed diameter d is in the range between about 0.60 and about 0.90, more preferably between about 0.65 and about 0.85, and most preferably between about 0.68 and about 0.78. Accordingly, the ridge 27 preferably has a height in the range between about 0.40 and 0.75 of the uncompressed diameter of the body portion of the second O-ring 22, more preferably between about 0.50 and 0.70 of the uncompressed diameter of the body portion of the second O-ring 22, and most preferably between about 0.55 and 0.65 of the uncompressed diameter of the body portion of the second O-ring 22. It should be appreciated, however, that other ratios between the height of the ridge and the uncompressed diameter of the body portion of the second O-ring 22 (h/d) and between the compressed and uncompressed body portion diameters of the second O-ring 22 (d′/d) may also be used according to the present invention.

One of the significant advantages of the disclosed clearance seal assembly is the fact that the combination of the housing member 26, the sealing member 25, the first elastomeric seal 21 and the second elastomeric seal 22 constitutes a self-contained module that can be easily removed from the stationary casing 23 for cleaning and/or maintenance when necessary.

As disclosed in U.S. Pat. No. 6,843,481, a fluid seal can be formed between a moving and a stationary member without a direct contact between them. The size of the gap 33 may be selected to allow the fluid to fill the gap between the seal and piston, thus avoiding a dry friction, but to prevent the fluid from flowing through the gap. When the clearance gap is sufficiently small, the adhesive forces of the fluid toward the piston and the seal are greater than the force exerted by the fluid due to an operating pressure, thus preventing the fluid from flowing through the gap.

The ranges of suitable sizes of the gap 33 depend on the physical properties of the fluid being pumped, such as viscosity, surface tension, adhesive force, temperature and operating pressure differential. Low viscosity fluids will typically require a smaller gap 33 than higher viscosity fluids. Generally, the higher viscosity of a fluid, the broader range of the gaps 33 may be used. In one embodiment, the gap 33 has a size in the range between about 0.5 micron and about 3.0 microns, more preferably between about 0.75 micron and about 2.0 microns, and most preferably between about 1.0 micron and about 1.5 microns. It should also be recognized that the size of the gap greatly depends on a type of application. Those skilled in the art can select the size of the gap to accommodate fluids and operating pressures used in a particular application without undue experimentation in view of the instant disclosure.

In one embodiment, the fluid being pumped comprises water or an aqueous buffer solution such as, for example, a phosphate-buffered saline solution, phosphate buffer, borate buffer, citrate buffer, Tris buffer, MOPS buffer, PIPES buffer or HEPES buffer. The viscosity of the aqueous buffer solution is preferably in the range between about 0.3 cP (3×10⁻⁴ Pa·s) and about 20 cP (2×10⁻² Pa·s), more preferably between about 0.5 cP (5×10⁻⁴ Pa·s) and about 5 cP (5×10⁻³ Pa·s), and most preferably between about 0.9 cP (9×10⁻⁴ Pa·s) and about 1.5 cP (1.5×10⁻³ Pa·s). It must be understood, however, that other appropriate fluids may also be used according to the invention.

The temperature of the fluid being pumped is preferably in the range between about 10° C. and about 90° C., more preferably between about 15° C. and about 60° C., and most preferably between about 20° C. and about 30° C. The operating pressure differential is preferably less than about 1000 kPa, more preferably less than about 500 kPa, and most preferably less than about 350 kPa. It must be understood, however, that other appropriate temperatures and operating pressures may also be used according to the invention.

Maintaining a uniform gap between the piston 24 and the sealing member 25 requires closely controlled radial dimensions of an external wall 31 of the piston and the internal wall 34 of the sealing member and a high assembling precision. Consequently, to simplify the control of the critical gap 33, in the preferred embodiment, the cross-sections of the internal wall 34 and the external wall 31 have substantially circular shapes.

Materials having a high hardness and can be machined with a desired high degree of precision may be used to make the sealing member and the piston and would be known to those of ordinary skill in the art in view of this disclosure. In one embodiment, the sealing member is made of a different material than the housing member. For example, the piston may be made of a ceramic material, whereas the sealing member may be made of a polymer, such as, for example, an acrylic polymer. In another embodiment, the sealing member is made of the same material as the housing member. For example, both the sealing member and the piston may be made of ceramic materials.

Although the invention is described with a particular reference to a piston pump, it should be recognized that the general features of the clearance seal may be utilized in any device having a stationary member, such as the casing 23, with an opening, such as the pressure chamber 30, and a moving member, such as the piston 24, moveably disposed through the opening. Generally speaking, the stationary member may have any shape so long as it defines two volumes, such as inside and outside of the pump, referred to as two sides of the stationary member, and connected by the opening. The two volumes may contain different fluids and/or be under different pressure (e.g. operating fluid pressure inside the pump and atmospheric pressure outside the pump).

The present invention may be embodied in other specific forms without departing from its essential characteristics. The described embodiment is to be considered in all respects only as illustrative and not as restrictive. All changes which come within the meaning and range of the equivalence of the claims are to be embraced within their scope.

1. A self-aligning clearance seal assembly, comprising:
(a) a stationary casing defining a first side, a second side, and an opening connecting the first and second side;
(b) a moving member having an external wall, said moving member moveably disposed through said opening;
(c) a housing member having an internal wall and a ridge forming a recess in said housing member, said housing member circumferentially disposed between said stationary casing and said moving member;
(d) a sealing member having an internal wall, an external wall, a top surface, and a bottom surface, said sealing member circumferentially disposed between said housing member and said moving member;
(e) a first elastomeric seal disposed between said stationary casing and the top surface of said sealing member; and
(f) a second elastomeric seal disposed in the recess between said housing member and the bottom surface of said sealing member.
wherein the internal wall of said housing member and the external wall of said sealing member define a first gap, and said first elastomeric seal prevents a fluid from flowing into said first gap;
said second elastomeric seal, when compressed, prevents the ridge of said housing member from biasing against the bottom surface of said sealing member.

2. The self-aligning clearance seal assembly of claim 1, wherein the sealing member floats between the first elastomeric seal and the second elastomeric seal and self-aligns with the moving member.

3. The self-aligning clearance seal assembly of claim 1, wherein the internal wall of said sealing member and the external wall of said moving member, when assembled, define a continuous and uniform second gap;
said second gap has a size that allows said fluid to fill said second gap but prevents said fluid from flowing through said second gap from the first side to the second side of said opening under an operating pressure differential between the first and the second side; and
the size of said second gap remains substantially unchanged under said operating pressure differential.

4. The self-aligning clearance seal assembly of claim 1, wherein said second gap ranges in size from about 0.75 micron to about 2.0 microns.

5. The self-aligning clearance seal assembly of claim 1, wherein said operating pressure differential is less than about 350 kPa.

6. The self-aligning clearance seal assembly of claim 1, wherein said second elastomeric seal has an uncompressed body portion diameter and a compressed body portion diameter, and the ratio of said compressed diameter to said uncompressed diameter ranges from about 0.65 to about 0.85.

7. The self-aligning clearance seal assembly of claim 1, wherein the ridge of said housing member has a height, and said second elastomeric seal has an uncompressed body portion diameter, and the ratio of said height to said uncompressed diameter ranges from about 0.50 to about 0.70.

8. The self-aligning clearance seal assembly of claim 1 included in a pump.

9. A pump, comprising:
(a) a stationary casing having an internal wall defining a pressure chamber for containing a fluid;
(b) a piston having an external wall, said piston movably disposed within said chamber;
(c) a housing member having a ridge forming a recess in said housing member, said housing member circumferentially disposed between said stationary casing and said piston;
(d) a sealing member having an internal wall, an external wall, a top surface, and a bottom surface, said sealing member circumferentially disposed between said housing member and said piston;
(e) a first elastomeric seal disposed between said stationary casing and the top surface of said sealing member; and
(f) a second elastomeric seal disposed in the recess between said housing member and the bottom surface of said sealing member,
wherein the sealing member floats between the first elastomeric seal and the second elastomeric seal and self-aligns with the piston.

10. The pump of claim 9, wherein said sealing member is made of a ceramic material.

11. The pump of claim 9, wherein said fluid comprises water or an aqueous buffer solution.

12. The pump of claim 9, wherein said first and second elastomeric seals is each an annular elastomeric seal (O-ring).

13. A pump, comprising:
a housing including an internal wall sized to receive a moving member and a groove disposed in the internal wall of the housing, the groove having an upper surface and a lower surface;
a sealing member including a top surface and a bottom surface, the sealing member disposed within the groove;
a first elastomeric seal disposed between the upper surface of the groove and the top surface of the sealing member, the first elastomeric seal configured to form an upper gap between the upper surface of the groove and the top surface of the sealing member; and
a second elastomeric seal disposed between the lower surface of the groove and the bottom surface of the sealing member, the second elastomeric seal configured to form a lower gap between the lower surface of the groove and the bottom surface of the sealing member;
wherein the sealing member floats between the first elastomeric seal and the second elastomeric seal and self-aligns with the moving member.

14. The pump of claim 13, the groove further having a back wall disposed circumferentially in the housing, the sealing member further including an external wall wherein the back wall of the groove and the external wall of the sealing member define an outer gap, and the first elastomeric seal prevents a fluid from flowing into the outer gap.

15. The pump of claim 13, wherein said moving member is a piston, the piston including an external wall, the piston movably disposed within the internal wall of the housing, the sealing member further including an internal wall, the internal wall of the sealing member and the external wall of the piston, when assembled, define an inner gap, the inner gap having a size that allows fluid to fill the inner gap but prevents the fluid from flowing through the inner gap from one end of the housing to the other end under an operating pressure differential.

16. The pump of claim 15, wherein the inner gap ranges in size from about 0.75 micron to about 2.0 microns.

17. The pump of claim 15, wherein the operating pressure differential is less than about 350 kPa.

18. The pump of claim 13, the housing including a stationary casing and a housing member, the housing member disposed circumferentially inward of the stationary casing, wherein the first elastomeric seal is mounted between the top surface of the sealing member and the stationary casing and the second elastomeric seal is mounted between the bottom surface of the sealing member and the housing member.

19. The pump of claim 18, the housing member having a ridge forming a recess in the housing member, wherein the ratio of the height of the ridge of the housing member to the uncompressed body portion diameter of the second elastomeric seal ranges from about 0.50 to about 0.70.

20. The pump of claim 13, wherein the ratio of the compressed body portion diameter of the second elastomeric seal to the uncompressed body portion diameter of the second elastomeric seal ranges from about 0.65 to about 0.85.
